(19) United States
(12) Patent Application Publication
(10) Pub. No.: US 2024/0195036 A1
(43) Pub. Date: Jun. 13, 2024

(54) CONDUCTIVE CONNECTION ASSEMBLY

(71) Applicant: HONDA MOTOR CO., LTD., Tokyo (JP)

(72) Inventors: Hideki SAKAMOTO, Saitama (JP); Harumi Takedomi, Saitama (JP)

(73) Assignee: HONDA MOTOR CO., LTD., Tokyo (JP)

(21) Appl. No.: 18/531,286

(22) Filed: Dec. 6, 2023

(30) Foreign Application Priority Data
Dec. 9, 2022 (JP) 2022-197003

(51) Int. Cl. H01M 50/591; H01M 50/505; H01M 50/517

(52) U.S. Cl. CPC H01M 50/591; H01M 50/505; H01M 50/517

(57) ABSTRACT

A conductive connection assembly is connected to a cell group including a plurality of stacked battery cells. The conductive connection assembly includes: a conductive connection member configured to be connected to the cell group; and a cover covering the conductive connection member. The conductive connection member is connected to the cell group by a fastening member, the cover is provided with an insertion hole configured to allow a tool for fastening the fastening member to be inserted, the cover is spaced apart from the fastening member, and is configured to transition between a first position where the insertion hole and the fastening member face each other and a second position where the insertion hole and the fastening member do not face each other, and the cover in the second position is located closer to the conductive connection member than the cover in the first position.

### CROSS-REFERENCE TO RELATED APPLICATIONS

This application is based on and claims priority under 35 USC 119 from Japanese Patent Application No. 2022-197003 filed on Dec. 9, 2022, the contents of which are incorporated herein by reference.

### TECHNICAL FIELD

The present disclosure relates to a conductive connection assembly connected to a cell group including a plurality of stacked battery cells.

### BACKGROUND

In recent years, researches and developments have been conducted on a secondary battery which contributes to improvement in energy efficiency in order to allow more people to have access to affordable, reliable, sustainable and advanced energy.

In the related art, a large-capacity battery pack including a plurality of battery modules is mounted on an electric vehicle or the like. For example, Patent Literature 1 describes a battery pack in which a plurality of battery modules are mounted in a case. The plurality of battery modules are electrically connected in series by electrically conducting adjacent battery modules via a bus bar.

Japanese Patent Application Laid-open Publication No. 2021-125429 (hereinafter, referred to as Patent Literature 1) discloses that during maintenance, a worker using a tool to detach a bus bar fixing bolt from above and to release the electrical conduction between the adjacent battery modules. Here, the space above the bus bar fixing bolt is provided with an access allowing portion (opening) that allows a tool to be inserted, and is provided with a contact restricting portion to prevent the fingers of the worker from having contact with the live part such as the bus bar fixing bolt or the bus bar by mistake.

Patent Literature 1 can ensure safety when a worker uses a tool to perform maintenance or the like on the contact restricting portion, but leaves room for improvement in the space saving of the battery pack.

An object of the present disclosure is to provide a conductive connection assembly that can save space while ensuring safety when working using a tool.

### SUMMARY

An aspect of the present disclosure relates to a conductive connection assembly for being connected to a cell group including a plurality of stacked battery cells. The conductive connection assembly includes: a conductive connection member configured to be connected to the cell group; and a cover covering the conductive connection member. The conductive connection member is connected to the cell group by a fastening member, the cover is provided with an insertion hole configured to allow a tool for fastening the fastening member to be inserted, the cover is spaced apart from the fastening member, and is configured to transition between a first position where the insertion hole and the fastening member face each other and a second position where the insertion hole and the fastening member do not face each other, and the cover in the second position is located closer to the conductive connection member than the cover in the first position.

### BRIEF DESCRIPTION OF DRAWINGS

Exemplary embodiments of the present disclosure will be described in detail based on the following figures, wherein:

FIG. 1 is a schematic perspective view illustrating an internal structure of a battery pack 1;

FIG. 2 is a schematic plan view schematically illustrating an electrical flow path of the battery pack 1;

FIG. 3 is a perspective view of a laminated cell 2;

FIG. 4 is a perspective view of a conductive connection assembly 5 of a first embodiment of the present disclosure provided in the battery pack 1;

FIG. 5 is an exploded perspective view of the conductive connection assembly 5 of the first embodiment:

FIG. 6 is a diagram comparing a distance L1 between notches 62 provided in first guide grooves 61A and notches 62 provided in second guide grooves 61B and a distance L2 between first protrusions 72A and second protrusions 72B:

FIG. 7 is a diagram illustrating transition of the cover 70 from the first position P1 to the second position P2 in the conductive connection assembly 5 of the first embodiment;

FIG. 8 is a cross-sectional view taken along line X-X in FIG. 4;

FIG. 9 is a perspective view of a conductive connection assembly 5 of a second embodiment of the present disclosure provided in the battery pack 1:

FIG. 10 is an exploded perspective view of the conductive connection assembly 5 of the second embodiment; and

FIG. 11 is a diagram illustrating transition of the cover 70 from the first position P1 to the second position P2 in the conductive connection assembly 5 of the second embodiment.

### DESCRIPTION OF EMBODIMENTS

Hereinafter, a conductive connection assembly of each embodiment of the present disclosure will be described with reference to the drawings. The drawings are to be viewed in the direction of reference signs. In the following description, for the convenience of description, front, rear, left, right, upper and lower are set for the sake of convenience. In the drawings, Fr denotes the front side, Rr denotes the rear side, L denotes the left side, R denotes the right side, U denotes the upper side, and D denotes the lower side.

### First Embodiment

First, a battery pack 1 provided with a conductive connection assembly 5 according to a first embodiment of the present disclosure will be described.

### <Battery Pack>

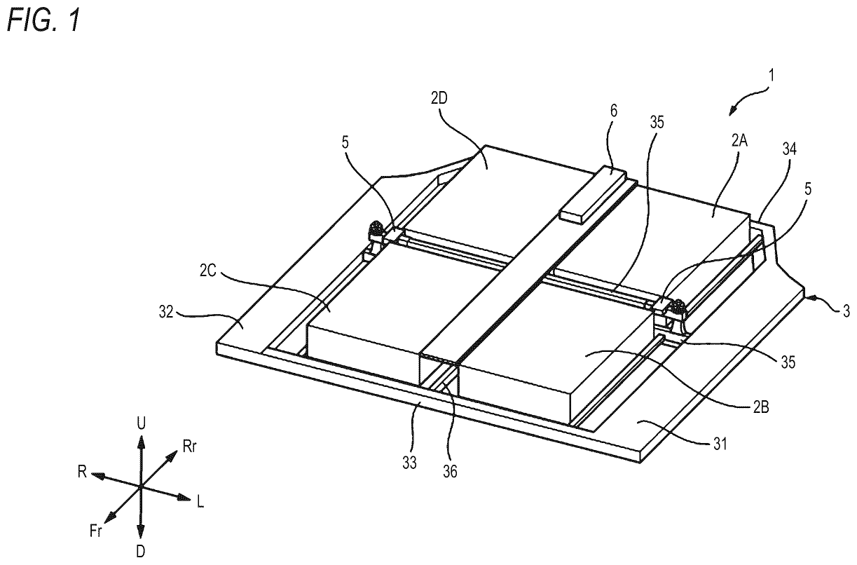

As illustrated in FIGS. 1 to 3, the battery pack 1 includes a plurality of laminated cells 2 laminated in the horizontal direction (in the present embodiment, the left-right direction), and a battery case 3 accommodating the plurality of laminated cells 2, and is, for example, arranged under the floor (under the floor panel) of a vehicle (not illustrated).

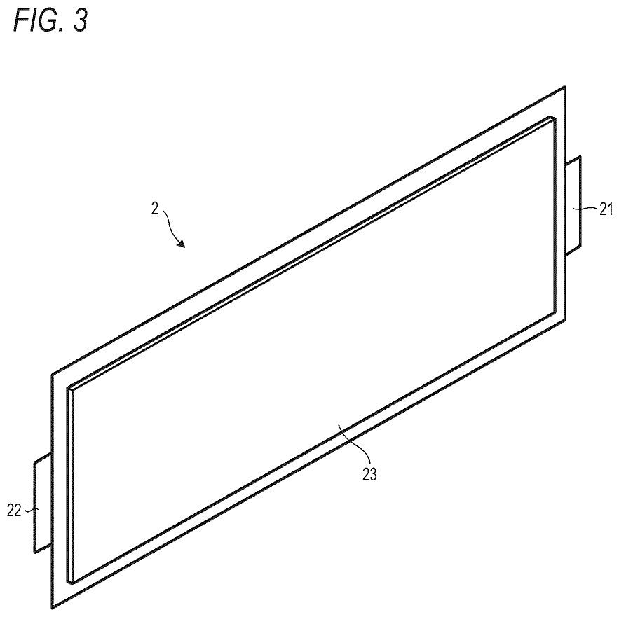

The laminated cells 2 are, for example, solid-state batteries. As illustrated in FIG. 3, the laminated cells 2 configured with solid-state batteries each have a positive electrode to which a positive electrode tab lead 21 is coupled, a negative electrode to which a negative electrode tab lead 22 is coupled, a solid electrolyte disposed between the positive electrode and the negative electrode, and a laminate film 23 housing the above. The laminated cell 2 charges and discharges based on the transfer of lithium ions between the positive electrode and the negative electrode via the solid electrolyte.

The solid electrolyte of the solid-state battery is not particularly limited and can be generally materials used in all-solid-state lithium ion batteries, as long as it has lithium ion conductivity and insulating property. Examples thereof include: inorganic solid electrolytes such as sulfide solid electrolyte materials, oxide solid electrolyte materials, and lithium-containing salts; polymer solid electrolytes such as polyethylene oxide; and gel solid electrolytes including lithium salts and conductive ionic liquids having ion conductivity for lithium ions. The form of the solid electrolyte material is not particularly limited. As an example, the form may be particulate.

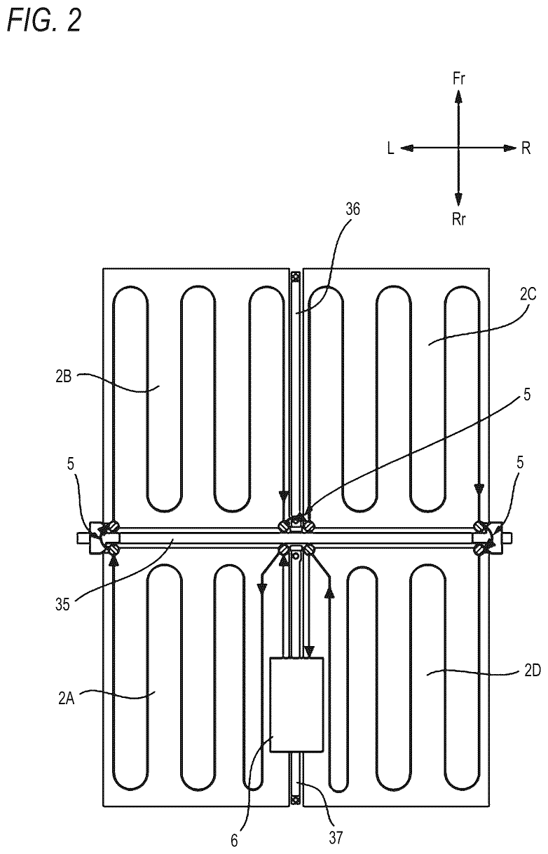

As illustrated in FIGS. 1 and 2, the plurality of laminated cells 2 are divided into a plurality of cell groups 2A to 2D. For example, the battery case 3 is divided into a first cell group 2A disposed at the left rear portion of the battery case 3, a second cell group 2B disposed at the left front portion of the battery case 3, a third cell group 2C disposed at the right front portion of the battery case 3, and a fourth cell group 2D disposed at the right rear portion of the battery case 3. The plurality of cell groups 2A to 2D are spaced apart at predetermined intervals in the horizontal direction.

Among the plurality of laminated cells 2 constituting each of the cell groups 2A to 2D are, for example, two adjacent laminated cells 2 and 2 are connected in parallel, and the laminated cells 2 and 2 connected in parallel are electrically connected in series to the adjacent laminated cells 2 and 2 connected in parallel. Among the plurality of laminated cells 2, all the cells may be connected in series, and the type of connection is not limited.

The cell groups 2A to 2D are electrically connected in series via conductive connection assemblies 5. For example, the electrical flow path start of the first cell group 2A is connected to the wiring connection box 6, and the electrical flow path end of the first cell group 2A is connected to the electrical flow path start of the second cell group 2B via a conductive connection assembly 5. The electrical flow path end of the second cell group 2B is connected to the electrical flow path start of the third cell group 2C via a conductive connection assembly 5. The electrical flow path end of the third cell group 2C is connected to the electrical flow path start of the fourth cell group 2D via a conductive connection assembly 5. The end of the electrical flow path of the fourth cell group 2D is connected to the wiring connection box 6. The conductive connection assemblies 5 will be described in detail later.

As illustrated in FIG. 1, the battery case 3 has a frame structure in a grid shape in a plan view. As illustrated in FIGS. 1 and 2, the frame structure includes a pair of side frames 31 and 32 facing each other in the left-right direction so as to sandwich the cell groups 2A to 2D, a front frame 33 and a rear frame 34 facing each other in the front-rear direction so as to sandwich the cell groups 2A to 2D, an intermediate horizontal frame 35 disposed between the first cell group 2A and the second cell group 2B and between the third cell group 2C and the fourth cell group 2D, a first intermediate vertical frame 36 disposed between the second cell group 2B and the third cell group 2C, and a second intermediate vertical frame 37 disposed between the first cell group 2A and the fourth cell group 2D. According to such a battery case 3, not only the deformation of the battery case 3 at the time of collision can be prevented, but also the cell groups 2A to 2D can be protected from the impact at the time of collision.

### <Conductive Connection Assembly>

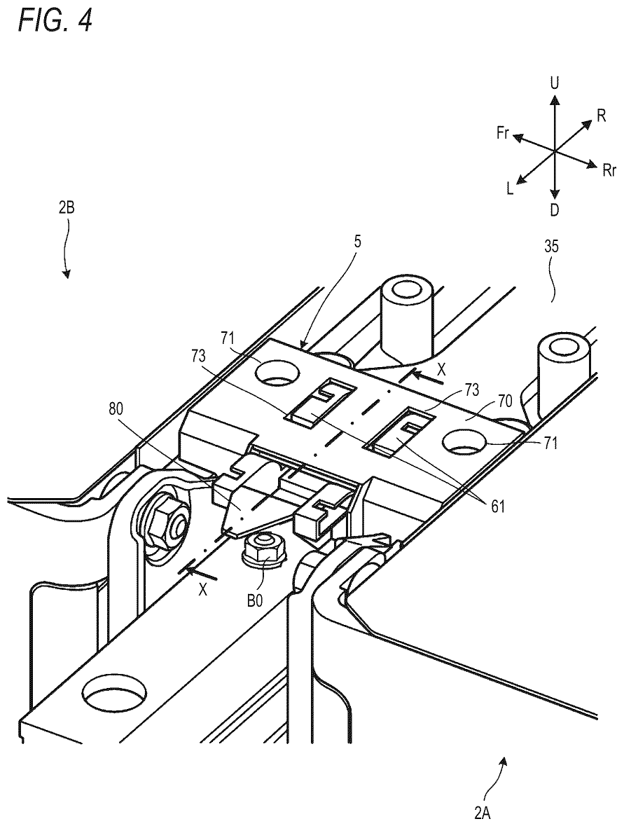

Next, conductive connection assemblies 5 according to a first embodiment of the present disclosure will be described with reference to FIGS. 4 to 7. In the following description, the conductive connection assembly 5 that connects the first cell group 2A and the second cell group 2B will be described. The conductive connection assembly 5 that connects the second cell group 2B and the third cell group 2C, and the conductive connection assembly 5 that connects the third cell group 2C and the fourth cell group 2D have the same configuration.

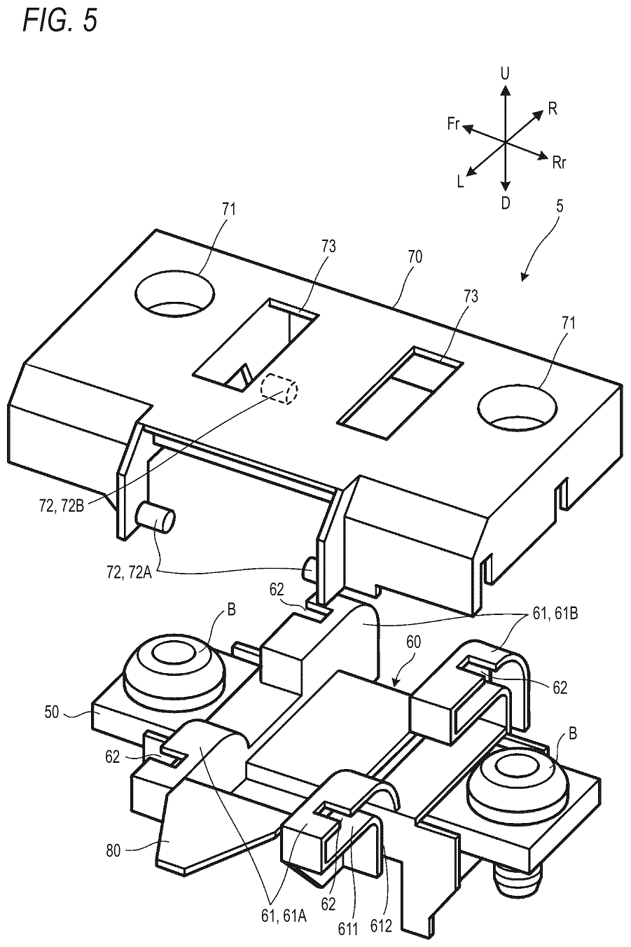

As illustrated in FIG. 4, the conductive connection assembly 5 is provided above the intermediate horizontal frame 35 disposed between the first cell group 2A and the second cell group 2B. As illustrated in FIG. 5, the conductive connection assembly 5 includes a conductive connection member 50, a holding portion 60, a cover 70, and an interlock portion 80.

The conductive connection member 50 is a member connecting the electrical flow path end of the first cell group 2A and the electrical flow path start of the second cell group 2B, and is, for example, a bus bar. The conductive connection member 50 is provided with bolt holes at both ends in the longitudinal direction. The conductive connection member 50 is fixed to the electrical flow path end of the first cell group 2A (for example, a bus bar) and the electrical flow path start of the second cell group 2B (for example, a bus bar) by fastening members such as bolts B inserted into the bolt holes.

The holding portion 60 is disposed above the intermediate horizontal frame 35 and holds the conductive connection member 50. The holding portion 60 is fixed to the battery pack I by the conductive connection member 50 being fixed to the electrical flow path end of the first cell group 2A and the electrical flow path start of the second cell group 2B by bolts B. The holding portion 60 is integrally provided with the interlock portion 80.

The holding portion 60 is provided with guide grooves 61 for guiding the movement of the cover 70. The guide grooves 61 include a pair of first guide grooves 61A provided apart from each other in the front-rear direction at the left side of the holding portion 60, and a pair of second guide grooves 61B provided apart from each other in the front-rear direction at the right side of the holding portion 60. The guide grooves 61 each have a substantially L-shape when viewed from the longitudinal direction of the conductive connection member 50 (here, the front-rear direction), and each include a lateral groove 611 extending in the horizontal direction and a vertical groove 612 extending from the lateral groove 611 toward the conductive connection member 50 downward in the present embodiment).

The guide grooves 61 are each provided with a notch 62. The notch 62 is provided in the guide groove 61 such that protrusions 72 of the cover 70 described later can be guided into the guide groove 61 from above. The protrusions 72 are guided from the notches 62 into the guide grooves 61 and move along the guide grooves 61.

The cover 70 is detachable from the holding portion 60 and covers the conductive connection member 50. The upper surface of the cover 70 is provided with a tool access hole 71. An insulating tool (not illustrated) can be inserted into the tool access hole 71 to access the conductive connection member 50 and the bolts B. The bolts B are, for example, hexagon socket head bolts whose bolt head has a hexagonal hole provided in the upper surface thereof. The tool access hole 71 is larger than the hexagonal holes of the bolts B and smaller than the bolt heads. The worker inserts the tool through the tool access hole 71 and uses the tool to fasten or loosen the bolts B.

The cover 70 is provided with four protrusions 72 protruding in the horizontal direction (only three protrusions 72 are illustrated in FIG. 5). The protrusions 72 include a pair of first protrusions 72A provided apart from each other in the front-rear direction on the left side of the cover 70, and a pair of second protrusions 72B provided apart from each other in the front-rear direction on the right side of the cover 70. The protrusions 72 are spaced apart from the upper surface of the cover 70 in the upper-lower direction. The pair of first protrusions 72A engages with the pair of first guide grooves 61A and moves along the first guide groove 61A. The pair of second protrusions 72B engages with the pair of second guide grooves 61B and moves along the second guide groove 61B. The protrusions 72 function as guide pins for guiding the movement of the cover 70.

The upper surface of the cover 70 is provided with two fitting holes 73, spaced apart from each other in the front-rear direction, for some of the guide grooves 61 to fit in. As will be described in detail later, when the cover 70 moves toward the conductive connection member 50 along the vertical grooves 612 of the guide grooves 61, some of the guide grooves 61 fits into the fitting holes 73 as illustrated in FIG. 4. Thus, the cover 70 and the guide grooves 61 do not interfere with each other even when the cover 70 moves toward the conductive connection member 50.

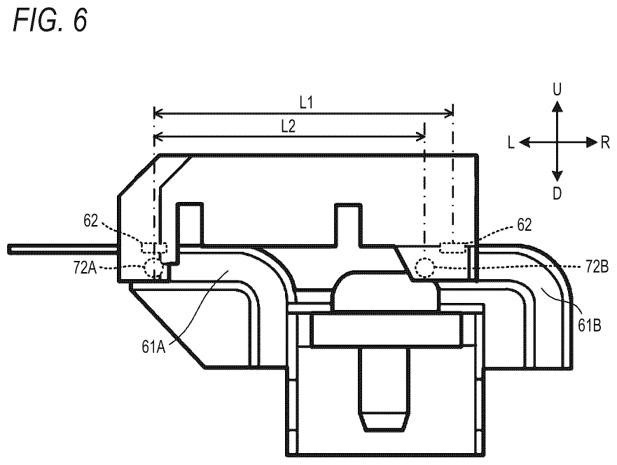

As illustrated in FIG. 6, the distance L1 between the notches 62 provided in the pair of first guide grooves 61A and the notches 62 provided in the pair of second guide grooves 61B is different from the distance L2 between the pair of first protrusions 72A and the pair of second protrusions 72B. In the present embodiment, the distance L1 is longer than the distance L2. According to such a configuration, when the protrusions 72 are guided from the notches 62 into the guide grooves 61, for example, the pair of first protrusions 72A are first guided from the notches 62 into the pair of first guide grooves 61A. Next, the pair of first protrusions 72A are slid in the pair of first guide grooves 61A, and the pair of second protrusions 72B are guided from the notches 62 into the pair of second guide grooves 61B. Accordingly, even when one of the first protrusions 72A and the second protrusions 72B is detached from the notch 62, the cover 70 continues to be held by the guide grooves 61, and the cover 70 can be prevented from being easily detached.

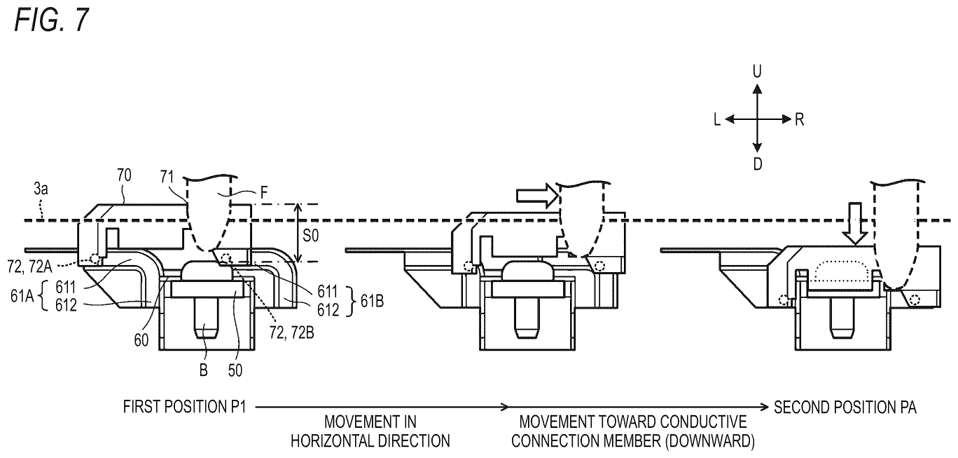

FIG. 7 is a view illustrating the movement of the cover 70 when the protrusions 72 are guided from the notches 62 into the guide grooves 61. As illustrated in FIG. 7, the cover 70 is spaced apart from the bolts B. and is capable of transitioning between a first position P1 where the tool access hole 71 and the bolts B face each other and a second position P2 where the tool access hole 71 and the bolts B do not face each other. The cover 70 located at the second position P2 is located closer to the conductive connection member 50 (lower in the present embodiment) than the cover 70 located at the first position P1.

Hereinafter, the transition of the cover 70 from the first position P1 to the second position P2 will be described in detail. When the cover 70 is at the first position P1, the worker can use a tool to fasten the bolts B to the conductive connection member 50 or loosen the bolts B. At the first position P1, the protrusions 72 are disposed in the lateral grooves 611 of the guide grooves 61. In the first position P1, the cover 70 is spaced apart from the bolts B, and a safe space 50 is provided between the tool access hole 71 and the bolts B. The safe space S0 is a space having a size that can prevent the worker's finger (the reference sign F in FIG. 7) or the like from coming into contact with the live part (the bolts B or the conductive connection member 50) even when entering the tool access hole 71 by mistake, and is provided for ensuring safety.

After the worker uses the tool to fasten the bolts B to the conductive connection member 50, the worker removes the tool from the tool access hole 71 and moves the cover 70 in the horizontal direction (the right direction in FIG. 7) along the lateral grooves 611. After the protrusions 72 of the cover 70 reach the vertical grooves 612, the cover 70 moves toward the conductive connection member 50 (downward) along the vertical grooves 612, and is positioned at the second position P2. Since the cover 70 moves in the horizontal direction before moving toward the conductive connection member 50, the tool access hole 71 and the live part do not face each other. Accordingly, even if the cover 70 moves toward the conductive connection member 50, it is possible to prevent the finger F of the worker from coming into contact with the live part even when entering the tool access hole 71 by mistake.

The second position P2 is a position at which the tool cannot access the bolts B, and is a position at which the attachment of the cover 70 is completed. In the present embodiment, when the cover 70 is located at the second position P2, as illustrated in FIG. 4, the position of the upper surface of the cover 70 and the positions of the upper surfaces of the cell groups 2A to 2D are substantially the same in the upper-lower direction.

In this way, the cover 70 transitions from the first position P1 to the second position P2 by the protrusions 72 moving along the guide grooves 61. Since the cover 70 moves along the guide grooves 61 engaged with the protrusions 72, the cover 70 can transition from the first position P1 to the second position P2 without being easily detached. Although not illustrated, the cover 70 can be transitioned from the second position P2 to the first position P1 by moving the protrusions 72 from the vertical grooves 612 of the guide grooves 61 to the lateral grooves 611.

As described above, the cover 70 is spaced apart from the bolts B, so that the worker's finger or the like does not come into contact with the live part by mistake when the worker uses the tool to perform the maintenance work by fastening the bolts B to the conductive connection member 50 or loosening the bolts B. Accordingly, the space from the cover 70 to the live part becomes the safe space S0, which can ensure safety of the work. Further, after the end of the work, the cover 70 is moved from the first position P1 to the second position P2, whereby the cover 70 is positioned closer to the conductive connection member 50 than is the first position P1. Thus, after the end of the work, the safe space S0 from the cover 70 to the live part can be reduced, which can save space.

Here, the space saving will be specifically described together with the battery cover 3a of the battery case 3. Assume a case where a safe space is provided from the cover of the conductive connection assembly to the live part and where the cover of the conductive connection assembly cannot transition from the first position P1 to the second position P2. In such a configuration, the cover is normally positioned at the first position P1, so that the safe space is maintained between the cover and the live part even after the end of the maintenance work. Accordingly, the height position of the battery cover 3a is designed to be higher than the height position of the cover in the first position P1.

On the other hand, in the present embodiment, the cover 70 of the conductive connection assembly 5 transitions from the first position P1 to the second position P2 after the maintenance work is completed. Since the cover 70 is positioned closer to the conductive connection member 50 at the second position P2, the space can be saved in the height direction. In the present embodiment, the height position of the battery cover 3a can be designed in consideration of the cover 70 located at the second position P2. For example, as illustrated in FIG. 7, the height position of the battery cover 3a may be set to be lower than the height position of the cover 70 in the first position P1 and higher than the height position of the cover 70 in the second position P2.

Returning to FIGS. 4 and 5, the interlock portion 80 of the conductive connection assembly 5 has a plate shape and extends from the holding portion 60. The interlock portion 80 faces the intermediate horizontal frame 35 in the upper-lower direction, and covers bolts B0 provided to the intermediate horizontal frame 35.

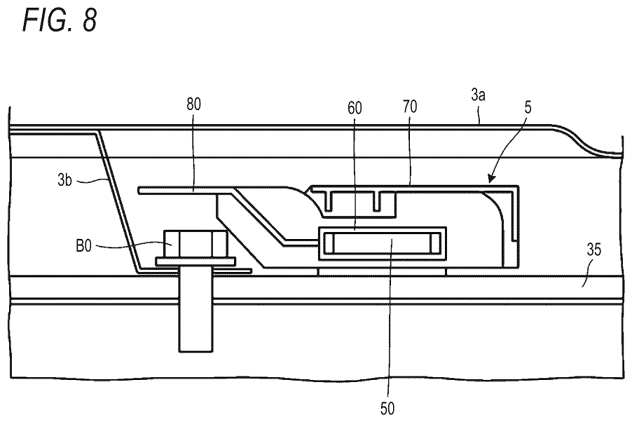

FIG. 8 is a cross-sectional view taken along line X-X in FIG. 4. As illustrated in FIG. 8, the bolts B0 are fastening members for fixing the cover support portion 3b, which is one part of the battery cover 3a, to the intermediate horizontal frame 35. In the present embodiment, the interlock portion 80 covers the bolts B0, so that the worker cannot access the bolts B0 or detach the bolts B0 as long as the interlock portion 80 is not detached, that is, as long as the conductive connection assembly 5 is not detached. In other words, the interlock portion 80 regulates the order of work of detaching the bolts B0 after detaching the conductive connection assembly 5.

### Second Embodiment

Next, a conductive connection assembly 5 according to a second embodiment of the present disclosure will be described. The components common to those of the first embodiment are denoted by the same reference signs, and description thereof is omitted.

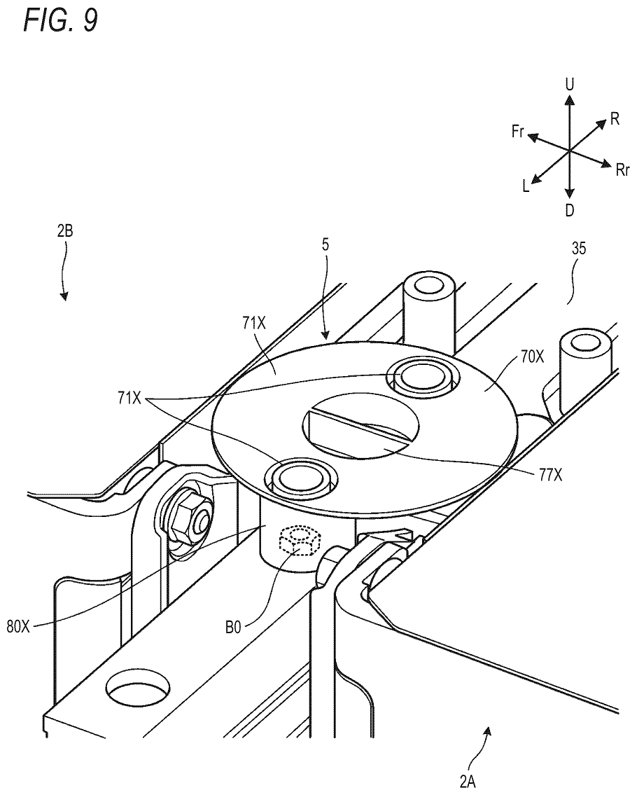

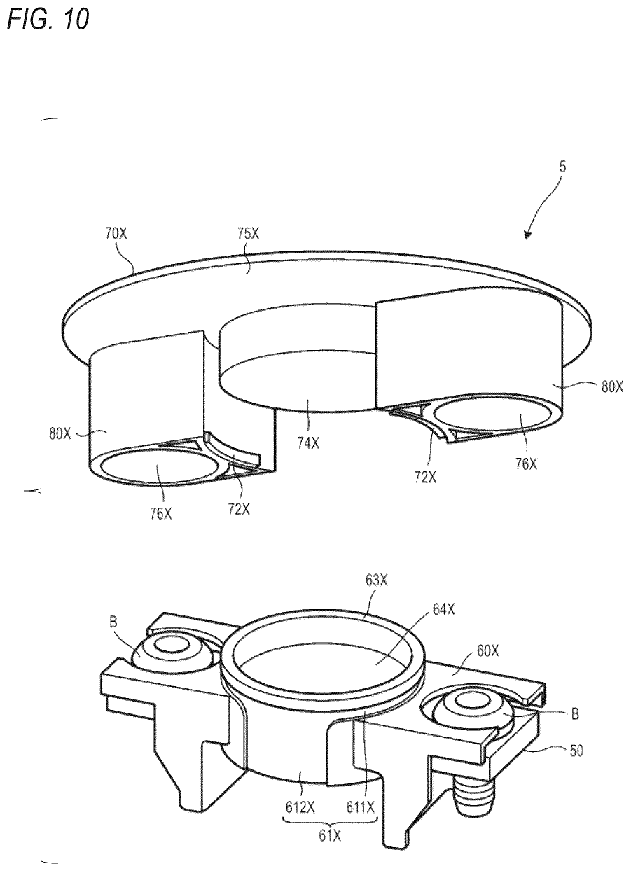

As illustrated in FIG. 9, similarly to the first embodiment, the conductive connection assembly 5 of the second embodiment is provided above the intermediate horizontal frame 35 disposed between the first cell group 2A and the second cell group 2B. As illustrated in FIG. 10, the conductive connection assembly 5 includes a conductive connection member 50, a holding portion 60X, a cover 70X, and an interlock portion 80X.

The holding portion 60X is disposed above the intermediate horizontal frame 35 and holds the conductive connection member 50. The central portion of the holding portion 60X is provided with a cylindrical cover support portion 63X. The upper portion of the cover support portion 63X is provided with a concave portion 64X having a circular cross section. The cover 70X is supported by the holding portion 60X by fitting the convex portion 74X of the cover 70X described later into the concave portion 64X. More specifically, the cover 70X is supported by the holding portion 60X in a manner rotatable about the central axis of the cylindrical convex portion 74X (that is, around an axis extending in the vertical direction).

The holding portion 60X is provided with guide grooves 61X for guiding the movement of the cover 70X. Specifically, the guide grooves 61X are formed on the outer peripheral surface of the cover support portion 63X of the holding portion 60X. Each of the guide grooves 61X includes a lateral groove 611X extending in the horizontal direction along the outer periphery on the upper portion of the outer peripheral surface of the cover support portion 63X, and a pair of vertical grooves 612X extending from the lateral groove 611X toward the conductive connection member 50 (downward in the present embodiment). The pair of vertical grooves 612X are provided on the left and right sides of the outer peripheral surface of the cover support portion 63X.

The cover 70X is detachable from the holding portion 60X and covers the conductive connection member 50. The upper surface of the cover 70X is provided with a tool access hole 71X (refer to FIG. 9). An insulating tool can be inserted into the tool access hole 71X to access the bolts B.

The cover 70X includes a plate body 75X, a convex portion 74X projecting from the lower surface of the plate body 75X and fitted into the concave portion 64X of the holding portion 60X, tool guide portions 76X projecting from the lower surface of the plate body 75X and communicating with the tool access holes 71X, and a knob 77X (see FIG. 9) to be pinched by the worker to manually rotate the cover 70X. The plate body 75X has a circular shape having a diameter that can cover the conductive connection member 50. The convex portion 74X is formed in a cylindrical shape having substantially the same diameter as the concave portion 64X of the holding portion 60X, which has a circular cross section, so as to fit into the concave portion 64X. The cover 70X rotates about the central axis of the convex portion 74X. Two tool guide portions 76X are provided corresponding to the positions of the bolts B and guide the tool from the tool access hole 71X to the bolts B when facing the bolts B. The knob 77X is provided at the center of the plate body 75X.

The tool guide portions 76X of the cover 70X are provided with two protrusions 72X protruding in the horizontal direction and toward the cover support portion 63X. The protrusions 72X are provided on the respective tool guide portions 76X. The protrusions 72X are provided to face each other. The protrusions 72X engage with the guide grooves 61X and guides the movement of the cover 70X by moving along the guide grooves 61X.

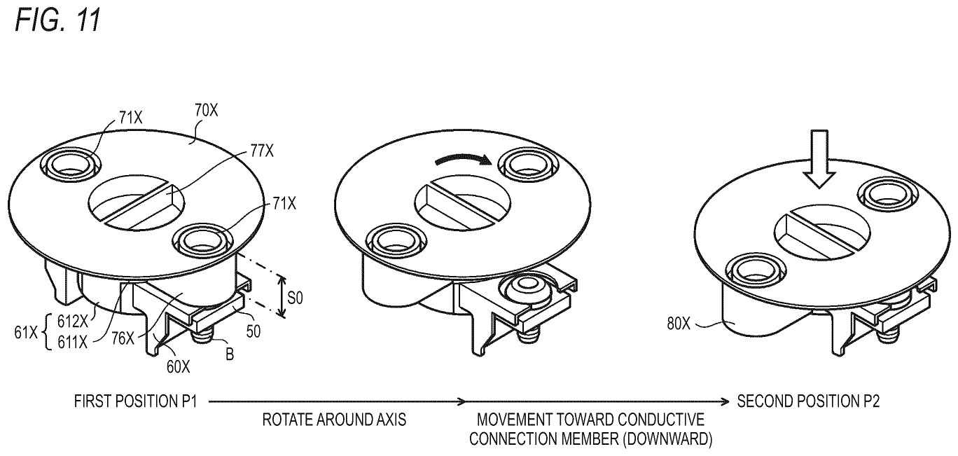

As illustrated in FIG. 11, the cover 70X is spaced apart from the bolts B. and is capable of transitioning between a first position P1 where the tool access hole 71X and the bolts B face each other and a second position P2 where the tool access hole 71X and the bolts B do not face each other. The cover 70X located at the second position P2 is located closer to the conductive connection member 50 (lower in the present embodiment) than the cover 70X located at the first position P1.

Hereinafter, the transition of the cover 70X from the first position P1 to the second position P2 will be described in detail. When the cover 70X is at the first position P1, the worker can use a tool to fasten the bolts B to the conductive connection member 50 or loosen the bolts B. At the first position P1, the protrusions 72X are disposed in the lateral grooves 611X of the guide grooves 61X. In the first position P1, the cover 70X is spaced apart from the bolts B, and a safe space S0 is provided between the tool access hole 71X and the bolts B. The safe space S0 is a space having a size that can prevent the worker's finger or the like from coming into contact with the live part even when entering the tool access hole 71X by mistake, and is provided for ensuring safety.

The worker uses the tool to fasten the bolts B to the conductive connection member 50, and then pinches the knob 77X and rotates the knob 77X by 90° around the central axis of the convex portion 74X, so that the cover 70X rotates along the lateral groove 611X. After the protrusions 72X of the cover 70X reach the vertical grooves 612X, the cover 70X moves toward the conductive connection member 50 (downward) along the vertical grooves 612X, and is positioned at the second position P2.

The second position P2 is a position at which the tool cannot access the bolts B, and is a position at which the attachment of the cover 70X is completed. In the present embodiment, when the cover 70X is located at the second position P2, as illustrated in FIG. 9, the position of the upper surface of the cover 70X and the positions of the upper surfaces of the cell groups 2A to 2D are substantially the same in the upper-lower direction.

The cover 70X transitions from the first position P1 to the second position P2 by the protrusions 72X moving along the guide grooves 61X. Although not illustrated, the cover 70X can be moved from the second position P2 to the first position P1 by moving the protrusions 72X from the vertical grooves 612X of the guide grooves 61X to the lateral grooves 611X.

Similarly to the conductive connection assembly 5 of the first embodiment, the conductive connection assembly 5 of the second embodiment described above can ensure safety of the work, and can save space.

Returning to FIGS. 9 and 10, the interlock portion 80X of the conductive connection assembly 5 includes the tool guide portions 76X of the cover 70X. When the cover 70X is at the second position P2, the interlock portion 80X (the tool guide portions 76X) covers the bolts B0 provided to the intermediate horizontal frame 35 from above. Similarly to the case of the first embodiment, the interlock portion 80X regulates the order of work of detaching the bolts B0 after detaching the conductive connection assembly 5.

Although various embodiments have been described above with reference to the drawings, it is needless to say that the present invention is not limited to these examples. It is apparent that those skilled in the art can conceive of various modifications and changes within the scope described in the claims, and it is understood that such modifications and changes naturally fall within the technical scope of the present invention. In addition, respective constituent elements in the above-described embodiment may be freely combined without departing from the gist of the invention.

For example, in the above-described embodiment, the laminated cells 2 are described as an example of the cells constituting the cell groups 2A to 2D, but are not limited thereto, and may be, for example, square cells.

In the above-described embodiment, the cover 70, 70X is provided with the protrusions 72, 72X, and the holding portion 60, 60X is provided with the guide grooves 61, 61X, which is not limited thereto. For example, the cover 70 and the cover 70X may be provided with guide grooves, and the holding portion 60, 60X may be provided with protrusions.

In the above-described embodiment, the cover 70 is provided above the conductive connection member 50, and the cover 70, 70X located at the second position P2 is located closer to the conductive connection member 50, i.e., lower than, the cover 70, 70X located at the first position P1. For example, when the cover 70 is provided on the lateral side of the conductive connection member 50, the cover 70, 70X in the second position P2 may be closer to the conductive connection member 50, that is, approaching the conductive connection member 50 more than is the cover 70, 70X in the first position P1. According to this configuration, it is possible to save space in the lateral portion of the conductive connection member 50.

In the present specification, at least the following matters are described. Although corresponding constituent elements or the like in the above-described embodiments are shown in parentheses, the present invention is not limited thereto.

(1) A conductive connection assembly (conductive connection assembly 5) for being connected to a cell group (cell groups 2A to 2D) including a plurality of stacked battery cells (laminated cells 2), the conductive connection assembly including:
a conductive connection member (conductive connection member 50) configured to be connected to the cell group; and
a cover (cover 70) covering the conductive connection member, in which
the conductive connection member is connected to the cell group by a fastening member (bolts B),
the cover is provided with an insertion hole (tool access hole 71, 71X) configured to allow a tool for fastening the fastening member to be inserted,
the cover is spaced apart from the fastening member, and can transition between a first position (first position P1) where the insertion hole and the fastening member face each other and a second position (second position P2) where the insertion hole and the fastening member do not face each other, and
the cover in the second position is located closer to the conductive connection member than the cover in the first position.

According to (1), when the cover is located at the first position where the insertion hole and the fastening member face each other, the cover is spaced apart from the fastening member. Therefore, the space from the cover to the live part becomes a safe space, which can prevent the worker's finger or the like from coming into contact with the live part by mistake when the worker works using a tool. Thus, safety of the work can be ensured. Further, the cover can transition to the second position where the insertion hole and the fastening member do not face each other. When the cover is in the second position, the cover is positioned closer to the conductive connection member, so that the safe space from the cover to the live part can be reduced, which can save space.

(2) The conductive connection assembly according to (1), further including:
a holding portion (holding portion 60, 60X) configured to hold the conductive connection member, in which
one of the cover and the holding portion is provided with a protrusion (protrusions 72, 72X), and the other is provided with a guide groove (guide grooves 61, 61X) configured to engage with the protrusion, and
the cover transitions between the first position and the second position by the protrusion moving along the guide groove.

According to (2), since the cover moves along the guide groove engaged with the protrusion, the cover can transition between the first position and the second position without being not easily detached.

(3) The conductive connection assembly according to (1) or (2), in which
the cover moves in a horizontal direction and moves toward the conductive connection member when transitioning from the first position to the second position.

According to (3), the movement in the horizontal direction and the movement toward the conductive connection member enables the transition of the cover from the first position at which safety of the work can be secured to the second position at which the space can be saved.

(4) The conductive connection assembly according to (1) or (2), in which
the cover rotates about an axis extending in a vertical direction and moves toward the conductive connection member when transitioning from the first position to the second position.

According to (4), the rotation around the axis extending in the vertical direction and the movement toward the conductive connection member enables the transition of the cover from the first position at which safety of the work can be secured to the second position at which the space can be saved.

(5) The conductive connection assembly according to any one of (1) to (4), in which
the conductive connection assembly is provided in a battery pack (battery pack 1) including the cell group, and
the conductive connection assembly further comprises an interlock portion (interlock portion 80, 80X) covering another fastening member (bolts B0) provided in the battery pack.

According to (5), the conductive connection assembly can also provide the interlock function of the battery pack. Therefore, no components having the interlock function need to be provided separately from the conductive connection assembly, which can save space.

1. A conductive connection assembly for being connected to a cell group including a plurality of stacked battery cells, the conductive connection assembly comprising:
a conductive connection member configured to be connected to the cell group; and
a cover covering the conductive connection member, wherein
the conductive connection member is connected to the cell group by a fastening member,
the cover is provided with an insertion hole configured to allow a tool for fastening the fastening member to be inserted,
the cover is spaced apart from the fastening member, and is configured to transition between a first position where the insertion hole and the fastening member face each other and a second position where the insertion hole and the fastening member do not face each other, and
the cover in the second position is located closer to the conductive connection member than the cover in the first position.

2. The conductive connection assembly according to claim 1, further comprising:
a holding portion configured to hold the conductive connection member, wherein
one of the cover and the holding portion is provided with a protrusion, and the other is provided with a guide groove configured to engage with the protrusion, and
the cover transitions between the first position and the second position by the protrusion moving along the guide groove.

3. The conductive connection assembly according to claim 1, wherein
the cover moves in a horizontal direction and moves toward the conductive connection member when transitioning from the first position to the second position.

4. The conductive connection assembly according to claim 1, wherein
the cover rotates about an axis extending in a vertical direction and moves toward the conductive connection member when transitioning from the first position to the second position.

5. The conductive connection assembly according to claim 1, wherein
the conductive connection assembly is provided in a battery pack including the cell group, and
the conductive connection assembly further comprises an interlock portion covering another fastening member provided in the battery pack.
